(19) United States
(12) Patent Application Publication
(10) Pub. No.: US 2015/0172817 A1
(43) Pub. Date: Jun. 18, 2015

(54) ACCOUSTIC SPEAKER SYSTEM

(71) Applicant: VASILEIOS TSAKIRIS, VRILISSIA (GR)

(72) Inventor: VASILEIOS TSAKIRIS, VRILISSIA (GR)

(21) Appl. No.: 14/564,124

(22) Filed: Dec. 9, 2014

(30) Foreign Application Priority Data
Dec. 13, 2013 (GR) 20130100694

(51) Int. Cl. H04R 5/02

(52) U.S. Cl. CPC H04R 5/02; H04R 2205/024

(57) ABSTRACT

A speaker system configuration and design and method of manufacture of same to reproducing stereo sound in a room using drivers placed on top and sides of a single speaker enclosure. The speaker drivers are supplied left (L), right (R), and left plus right (L+R) sound and configured to achieve sound power directivity of less than approximately 4 dB and sound power directivity variability of approximately ±3 dB over the frequency range of approximately 20 Hz to approximately 16 k Hz through speaker placement. A front driver may be added to the single enclosure c by radiating L+R stereo sound through the top and front drivers, while radiating L stereo through the left side driver and R stereo sound through the right side driver. A two speaker configuration is also provided wherein top and front firing drivers include L+R sound, while left facing drivers radiated left (L) sound, and right side drivers radiate right (R) sound.

### RELATED APPLICATIONS

This application claims benefit of Greek Patent Application No. 20130100694, filed on 13 Dec. 2013, entitled, “BALANCED DIRECTIVITY LOUDSPEAKERS”, commonly owned and assigned to the same assignee hereof and is hereby incorporated by reference.

### TECHNICAL FIELD

The present disclosure generally relates to an audio speaker system. In particular, the invention relates to compact acoustic speaker systems and techniques for reproducing stereo sound in an indoor room are presented.

### BACKGROUND

Acoustic speakers (“speakers”) have been used to reproduce audio sound, voice, and music for decades. Speakers generally include a combination of transducers and electronics configured to reproduce the sound as authentically as possible. Speakers are used in portable devices such as cellular phones, smartphones, tablets, computers, and music listening devices. Speakers are also used extensively for in-home entertainment systems, televisions, and stereo systems. Speakers may be standalone or mounted within a surface such as a wall. Speakers may be configured to reproduce monaural sound (single source) or may be configured to reproduce sound stereophonically. Stereophonic sound, as is known in the art, utilizes two or more channels of sound played simultaneously, with typical designations of at least a left (L) channel and right (R) channel. Multiple channels of sound can enhance the listener audio experience, as exemplified by the substantial technical and commercial development of surround sound systems for theaters, concert halls, and in-home audio/visual systems. In-home systems or systems that are confined to a room of a building may have physical size and location constraints of where speakers may be placed, or the design of such systems is such that the optimal listening position for authentic audio reproduction is very limited. For example, a home entertainment system may comprise a television and audio equipment including speakers. It is desirable to have authentic and robust audio reproduction throughout the potential listening area of said home entertainment system. Furthermore, compactness and cost are also a desirable trait.

Therefore, it is highly desirable, for a speaker system to be compact and cost effective while reproducing authentic sound throughout a large listening area.

### SUMMARY

The present disclosure describes techniques for the manufacture of a unique speaker system designed to reproduce stereo sound, including a left and right channel, from a single speaker enclosure and configured to achieve (i) sound power directivity of less than approximately 4 dB and (ii) sound power directivity variability of approximately ±3 dB over the frequency range of approximately 20 Hz to approximately 16 kHz. Directivity of less than approximately 4 dB and low sound power directivity variability results in a speaker system with pleasing reproduction of stereo sound in a compact package with a much lower cost to manufacture than more expensive and complicated solutions.

In one aspect, at least one speaker driver is placed on each of the left, top, and right sides of the speaker enclosure, wherein at least one acoustic driver on the top side radiates sound which may be L+R sound. A front firing speaker may be added which is a subwoofer, or may be a wide frequency range driver that also radiates L+R sound while the left side drivers radiate left channel sound and right side drivers radiate right channel sound.

In another aspect, a left and right side speaker enclosure is presented where the left side speaker enclosure has at least one left side driver and at least one top driver and the right side speaker enclosure has at least one right side driver and at least one top driver.

In another aspect, the phase between side and top mounted drivers may be radiated 180 degrees out of phase in order to increase frequency nulling of forward facing sound power.

The summary is neither intended nor should it be construed as being representative of the full extent and scope of the present disclosure, which these and additional aspects will become more readily apparent from the detailed description, particularly when taken together with the appended drawings.

### BRIEF DESCRIPTION OF THE DRAWINGS

FIG. 1 shows a spatial representation 100 of sound pressure measurement points in accordance with the ANSI/CEA-2034 standard.

FIG. 2 shows an example of standard data reporting 200 of speaker data in accordance with the ANSI/CEA-2034 standard.

FIG. 3A shows a traditional speaker design commercial example of flat sound power response 302 with non-uniform on-axis response 304.

FIG. 3B shows a traditional speaker design commercial example of flat on-axis power response 306 with non-uniform sound power response 308.

FIG. 4 shows a schematic block diagram of an acoustic speaker system in accordance with the present invention 400.

FIG. 5 shows an apparatus configuration and method of manufacture of an acoustic speaker 400 in accordance with the preferred embodiment.

FIG. 6 shows a schematic block diagram of an acoustic speaker system in accordance with an alternate embodiment 600.

FIG. 7 shows an apparatus configuration and method of manufacture of an acoustic speaker 600 in accordance with an alternate embodiment.

FIG. 8 shows invention performance 800 as measured by the standard, in accordance with the preferred embodiment 400.

FIG. 9 shows invention sound power 802, invention horizontal sound power 902, and invention vertical sound power 904 in accordance with the preferred embodiment.

FIG. 10 shows the invention estimated in-room response 1000 as measured by the standard in accordance with a preferred embodiment.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

The techniques and embodiments described herein may be used in any device where stereo sound is produced including, but not limited to, portable electronic devices, home stereo systems, home theater systems, computers, cellular phones, smartphones, and music players. The term “speaker” is used interchangeably with “audio speaker” or “loudspeaker” or “loud speaker” and other terms as is known in the art.

The present disclosure describes methods for manufacture and embodiments of a compact audio speaker system. Consumers of audio equipment, especially those with in-home stereo systems or in-home entertainment systems, desire compact speakers that provide authentic sound reproduction within a wide listening area while being cost effective. Perception of sound quality by a consumer, audiophile, general user or listener may be affected by several sound attributes, and some of the perception of sound quality is personal preference which may vary from person-to-person. Manufacturers of speaker systems and those skilled in the art quantify numerical performance specifications of speakers. These numerical performance specifications may be confusing to the average consumer. In an effort to better inform the consumer of relative product performance among different products from the same or different manufacturers, the Consumer Electronics Association (CEA), in accordance with the American National Standards Institute (ANSI) have developed and published many Standards, the latest to be the ANSI/CEA-2034 Standard (“the standard”), “Standard Method of Measurement for In-Home Loudspeakers,” November, 2013 and is hereby incorporated by reference. The use of the measurement techniques by a manufacturer as outlined in the ANSI/CEA-2034 standard is purely voluntary and is “designed to serve the public interest through eliminating misunderstandings between manufacturers and purchasers, facilitating interchangeability and improvement of products, and assisting the purchaser in selecting and obtaining with minimum delay the proper product for his need.” The foreword of the standard relates how the measurement standard will “convey a reasonably good representation of how it may sound in a room based on its off-axis response.” The standard also teaches that directivity frequency response data “correlates well to subjective listening preferences for consumers.”

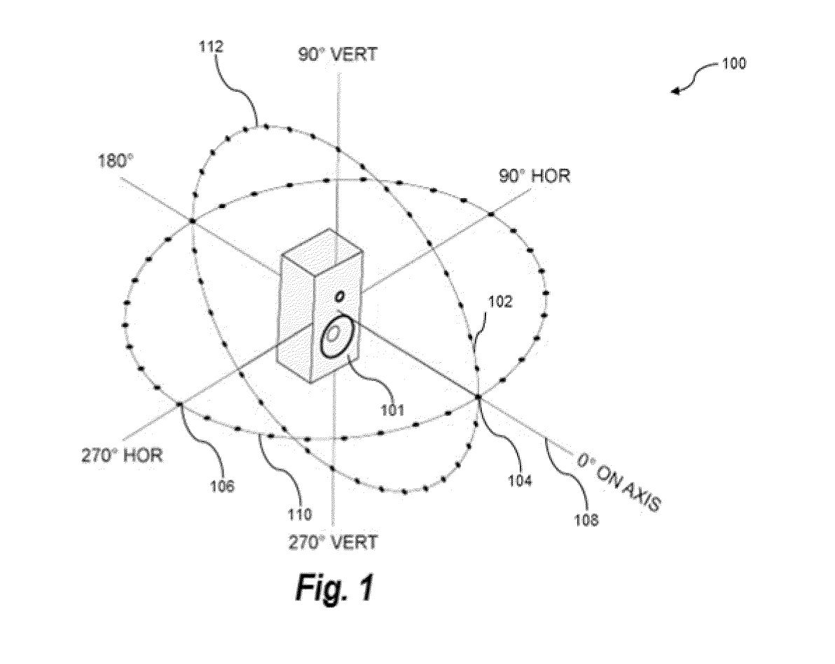

FIG. 1 shows a spatial representation 100 of sound pressure measurement points in accordance with the ANSI/CEA-2034 standard. The spatial representation as depicted in FIG. 1 is representative of example speaker 101 under test. “On-axis” direction 108 may be interpreted as the axis directly in front of the speaker, approximately perpendicular to the mounting plane of the forward facing speaker drivers. The standard further elaborates on-axis orientation. In real world applications, the audio listener would be positioned ideally in a location on-axis 108. The standard further defines a vertical orbit 112 which comprises points on a constant radius from the speaker under test in a vertical plane. The standard also further defines a horizontal orbit 110 which comprises points on a constant radius from the speaker under test in a horizontal plane. According to the standard, sound pressure level magnitude measurements are sampled in 10 degree increments around the horizontal orbit 110 and 10 degree increments around vertical orbit 112 resulting in 70 unique sound pressure level measurements. These sound pressure level magnitude measurements are then converted to sound power level (SPL in dB) in accordance to the procedures in the standard and as known in the art. Measurements are made for a plurality of frequencies, nominally ranging from 20 Hz to 20 kHz. Sound power response 207 is typically reported in the standard data reporting 200 of speaker data.

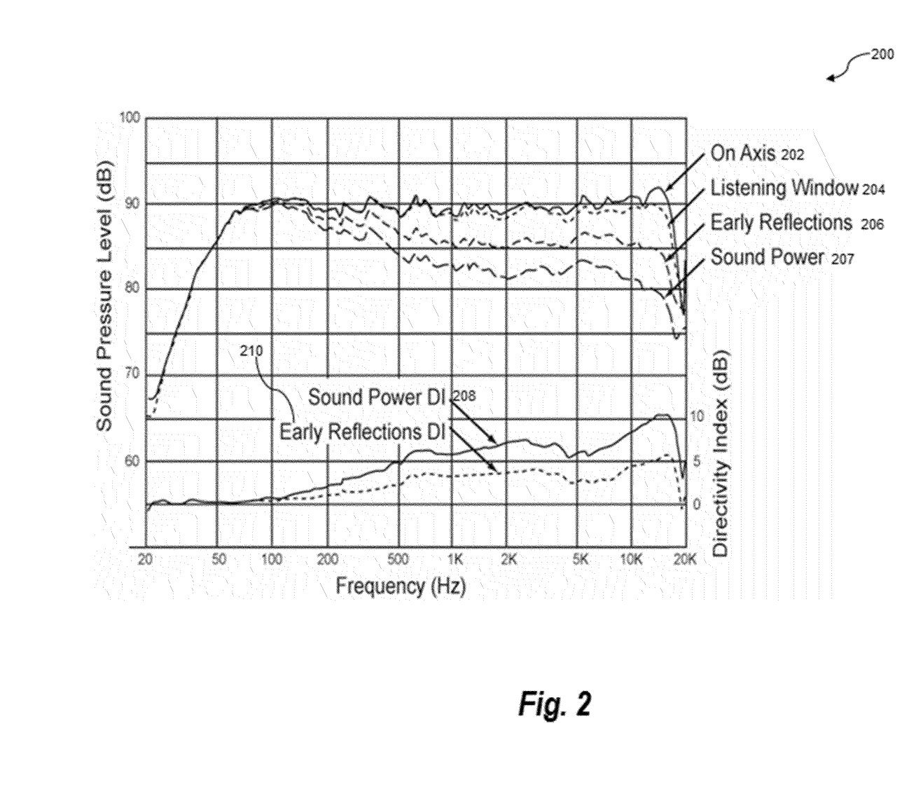

FIG. 2 shows an example of standard data reporting 200 of speaker data in accordance with the ANSI/CEA-2034 standard. In accordance with the standard, on-axis response 202 is superimposed with the listening window response 204, early reflections response 206 and sound power response 207. Furthermore, the standard data reporting 200 also includes a plot of the sound power directivity index 208 and early reflections directivity index 210. The ANSI/CEA standard committee teaches that the power responses depicted in standard data reporting 200 comprise enough technical information that a consumer can use to compare speaker systems. The standard data reporting 200, as depicted in FIG. 2, is that of an example speaker system under test and not the present invention. In practical applications, listeners are not always positioned in front of the speaker on-axis 108. The listening window, as defined by the standard, is “a spatial average of the 9 amplitude responses in the ±10° vertical and ±30° horizontal angular range.” The listening window better encompasses what a listener may encounter over a range of positions in front of a speaker. Home theater systems often have multiple listeners within a range of positions in front of the speakers.

According to the standard, a “bump” that may occur in any of the above standard data reporting 200 responses may be “an indication of resonance” which would be indicative of a poor sounding speaker system. Standard data reporting 200 also depicts early reflections response 206. According to the standard, early reflections response 206 is a linear combination of horizontal and vertical power measurements and represents a heuristic metric that the standard depicts as a good proxy for the sound reflections in an “average” room based upon research. Early reflections response 206 further may be an indication of “spaciousness” as perceived by a listener. Again, according to the standard, a “bump” that may occur in early reflections response 206 may represent a poor sounding speaker and may be characteristic of resonance, an undesirable trait as known in the art. Sound power directivity index (SPDI) 208 represents the difference, in dB, between the listening window response 204 and sound power response 208. Furthermore, early reflections directivity index (ERDI) 210 is defined as the difference, in dB, between early reflections response 206 and sound power response 207.

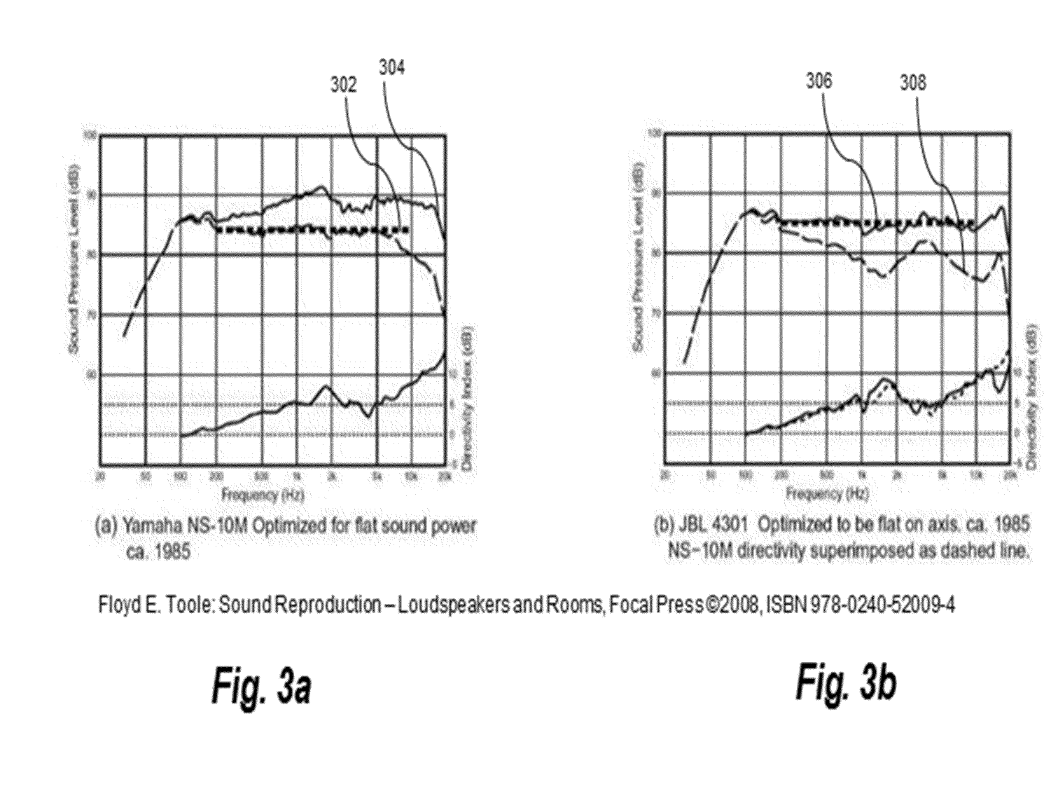

FIG. 3A shows a traditional speaker design commercial example of flat sound power response 302 with non-uniform on-axis response 304. Traditionally, speaker manufacturers have been placing mid-frequency and high-frequency speaker drivers on the front face of the speaker. With drivers facing in one direction, this commercial example of traditional design demonstrates that sound power response 302 is relatively “flat” while on-axis response 304 varies substantially over the entire frequency range.

FIG. 3B shows a traditional speaker design commercial example of flat on-axis power response 306 with non-uniform sound power response 308. When attempting to “flatten” out on-axis response 306, manufacturers have not been able to simultaneously “flatten” the power response 308. Images in FIGS. 3A and 3B are from Floyd E. Toole (“Toole”): Sound Reproduction—Loudspeakers and Rooms, Focal Press©2008, ISBN 978-0240-52009-4 and the publication is hereby incorporated by reference. Toole reports on research conducted by skilled artisans on sound quality including measures of speaker “pleasantness” and how “natural” a sound is. According to Klippel, as explained in “Toole” p. 458, in order to more objectively quantify the quality of audio sound, an objective measure was formed called “sense of space, R” and defined as:

R=L_{diffuse}−L_{direct},

wherein, L_{diffuse} is the overall sound power and L_{direct} is the on-axis response. Effectively, SPDI 208 is the negative of R above. According to Klippel's research reported by “Toole” p. 459, the optimal level of R (in dB) that maximizes a listeners “feeling of space” is approximately 3 dB for speech, approximately 4 dB for mixed audio, and approximately 5 dB for music. “Feeling of space,” according to Toole, is highly correlated to empirical measurements of speaker sound reproduction quality. Based upon the Toole reference, the best listening experience for a speaker system is to have a SPDI 208 of approximately −2 to approximately −5.5 dB. Traditional speaker systems with multiple front mounted midrange and high frequency drivers typically achieve SPDI 208 of greater than 10 dB, resulting in a poorer user experience. Also, an SPDI 208 variability of less than +−3 dB is desirable to minimize narrow band power variations which also contribute to a poor listening experience.

Toole further reports on additional experimentation which revealed that narrow band variations in directivity contributed to a richer sound listening experience. Thus, it is desirable to have speakers with sound power 207 and on-axis response 202 as well as SPDI 208 to not vary within 3 dB (to minimize narrow band variations) and simultaneously achieve an SPDI 208 magnitude of +5 dB to −5 dB from 300 Hz to 20 kHz. Furthermore, by having a near 0 dB (within 3 dB) SPDI 208, the improved listening experience extends further into the listening window. Toole reports that a speaker with SPDI 208 of 0 dB across the frequency range is considered omnidirectional, resulting in the same listening experience within a room. Negative directivity implies that the reflected or dispersed energy from acoustic drivers is greater than that of forward facing acoustic drivers, and contributes to a “feeling of space” (Toole). In practice, however, traditional speaker systems have not been able to minimize SPDI 208 variation and simultaneously have a negative magnitude of SPDI. The present invention solves this design problem through acoustic driver placement.

Furthermore, even well-known systems from companies such as BOSE had incorporated drivers which increased the radiated sound power so that sense of space R value was in excess of 9 dB (SPDI of −9) trying to maximize the feeling of space. But, as referenced above, Toole demonstrated that SPDI of −2 dB to about −5 dB were more “optimal.” The invention's inventors contend that the resulting “feeling of space” becomes “too much” and the listener, instead of perceiving a good sense of stereo directionality between left and right audio channels, perceives the audio as “coming from everywhere” such as in a concert hall. This is not as desirable for an in home or indoor speaker system. The present invention directs stereo sound of the left and right (and possibly combinations thereof) channel and is not to be confused with directing only “surround sound channel” sound.

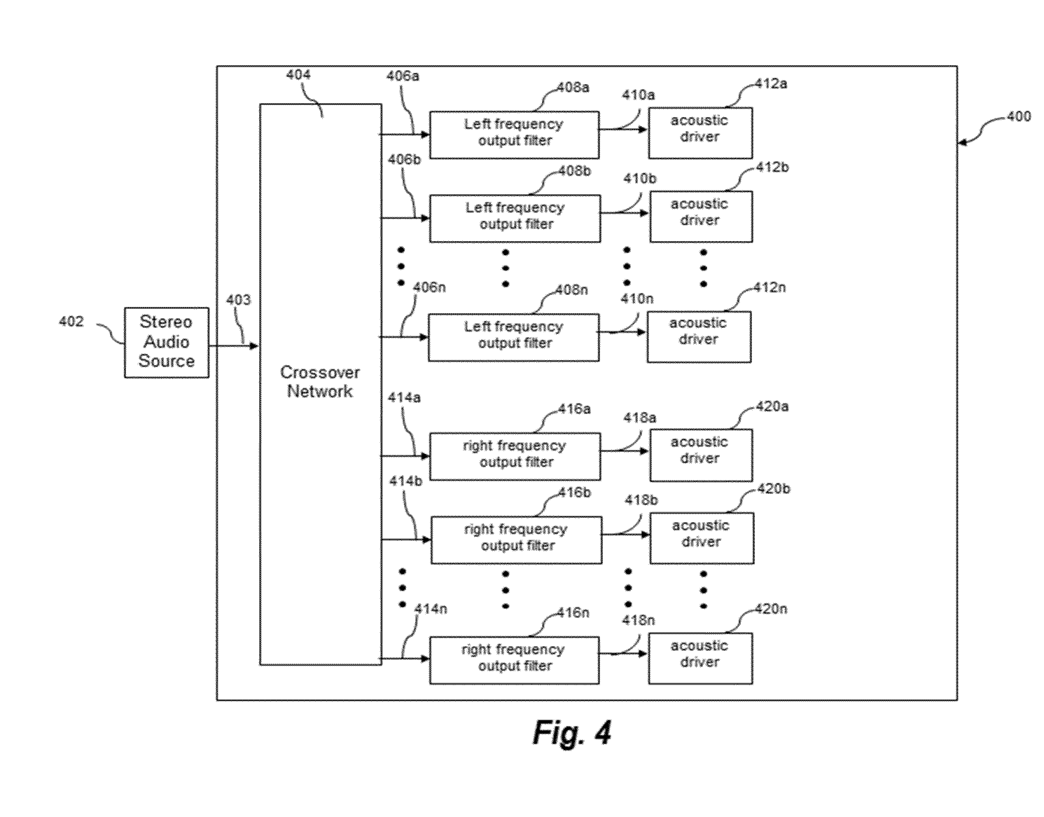

FIG. 4 shows a schematic block diagram of an acoustic speaker system in accordance with the present invention 400. Stereo audio source 402 is coupled to crossover network 404 via connection 403. Connection 403 may be an analog or digital or wireless, for example Bluetooth or Wi-Fi, or integrated digital media player, as is known in the art. Stereo audio source 402 may also comprise uncompressed digital formats such as WAV and AIFF, lossless compressed digital formats such as MPEG-4 SLS and FLAC, and lossy compression formats such as MP3 and AAC as is well known in the art. Furthermore, stereo audio source 402 may comprise signal components derived from surround sound technology as is well known in the art. Connection 403 may comprise a single connection or may be multiple connections. Stereo sound may be arranged as left and right, designated “L” and “R”, or may have mixed formats such as L+R, L−R and other variants. The term “channel” may refer to a single left or right side signal, as the terminology is well known in the art. Crossover network 404 conditions stereo audio source 402 and outputs two sets of signals: at least one left output signal 406a, 406b, . . . , 406n and at least one corresponding right output signal 414a, 414b, . . . , 414n. Crossover network 404 may utilize digital signal processing or analog active or passive circuitry as is known in the art. Digital signal processing may include a processor, memory, and other components as is known in the art. Crossover network 404 may also contain at least one power amplifier. The main functionality of crossover network 404 is to split up stereo audio source into two or more frequency bands, although typically low, mid, and high frequency, are known in the art. Low frequency bands may include frequencies from 20 Hz to 300 Hz. Mid frequencies may include frequencies from 300 Hz to 5000 Hz. High frequencies may include frequencies from 5000 Hz to 20000 Hz. Additional sub frequency bands may also be implemented by crossover network 404.

Digital signal processing that may be utilized in crossover network 404 may implement simple digital filters such as finite impulse response (FIR) filters and infinite impulse response (IIR) filters, or utilize sophisticated adaptive filtering techniques on a processor with memory and corresponding circuitry as is well known in the art. Left output signal 406a, 406b, . . . , 406n and right output signal 414a, 414b, . . . , 414n are coupled to left frequency output filter 408a, 408b, . . . , 408n and right frequency output filter 416a, 416b, . . . , 416n, respectively. Left frequency output filter 408a, 408b, . . . , 408n and right frequency output filter 416a, 416b, . . . , 416n may comprise additional signal conditioning such as active or passive filtering, digital or analog filtering. The purpose of the left and right frequency output filters is to enhance the performance characteristics of individual acoustic drivers 412 and 420.

As is known in the art, low frequency signals are typically coupled to low frequency acoustic drivers, mid frequency signals are coupled to mid frequency drivers and high frequency signals are coupled to high frequency drivers. Low frequency drivers radiating audio frequencies from 20-300 Hz typically have wide sound dispersion characteristics due to the physical propagation properties of those audio low frequencies in air. Low frequency drivers typically are larger, physically, in diameter, nominally greater than 3″ and are often referred to “woofers” or “subwoofers′. Mid-range frequency drivers typically are in the range of 1” to 5″ physical diameter and high frequency acoustic drivers typically are 1″ or less in diameter as is known in the art (also called “tweeters”).

Furthermore, acoustic drivers may be mounted concentric to one another. This concentric mounting may be typical for some sound systems that utilize a mid-range and “tweeter” driver concentrically located in order to achieve more physical compactness and achieve a potentially lower cost to manufacture due to fewer parts. Furthermore, left frequency output filter 408a, 408b, . . . , 408n and right frequency output filter 416a, 416b, . . . , 416n are coupled to left acoustic driver 412a, 412b, . . . , 412n and right acoustic driver 420a, 420b, . . . , 420n via left connection 410a, 410b, . . . , 410n and right connection 418a, 418b, . . . , 418n, respectively.

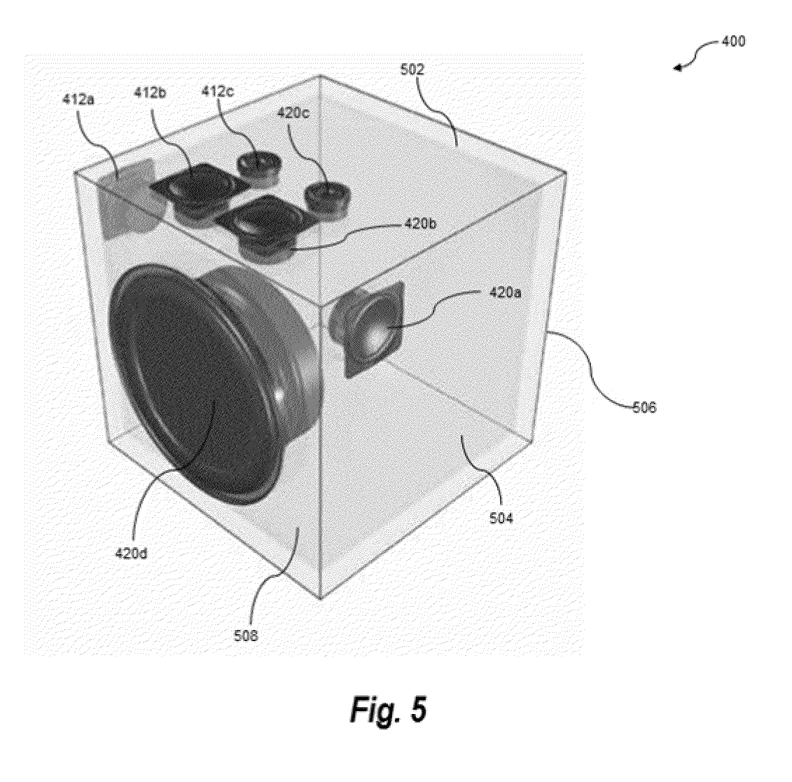

FIG. 5 shows an apparatus and method of manufacture of an acoustic speaker configuration 400 in accordance with the preferred embodiment. The acoustic speaker 400 to achieve SPDI 208 of less than 5 dB with a magnitude variation of SPDI of less than plus or minus 3 dB comprises driver 412a mounted on the left side of speaker enclosure 506, and driver 420a mounted on right side 504 of speaker enclosure 506, and drivers 412b, 412c, 420b, and 420c mounted on top side 502 of speaker enclosure 506, and driver 420d mounted on front side 508 of speaker enclosure 506.

The method of manufacture of acoustic speaker 400 to achieve SPDI of less than 5 dB with a magnitude variation of SPDI of less than ±3 dB comprises placing of driver 412a on the left side of speaker enclosure 506, and placing driver 420a on right side 504 of speaker enclosure 506, and placing drivers 412b, 412c, 420b, and 420c on top side 502 of speaker enclosure 506, and placing driver 420d on front side 508 of speaker enclosure 506. Front driver, 420d, comprises a low frequency (with a frequency response of approximately 20 Hz to 200 Hz) subwoofer and may be also placed on other faces of speaker enclosure 506. Low frequency acoustic propagation, as known in the art, behaves in an omnidirectional manner. Subwoofer drivers are regularly used in the art and performance of these subwoofers are not generally affected by physical placement, and thus, placement of driver 420d does not materially affect the ability of the present invention to deliver uniform directivity or negative directivity. Furthermore, in the preferred embodiment, 420d comprises a linear combination of the L and R components of stereo audio source 402. In the configuration depicted in FIG. 5, there is one low frequency driver 420d in the preferred embodiment where crossover network 404 can provide a linear combination of L and R components of stereo audio source 402 to low frequency driver 420d. The simplest linear combination would be a simple summation of L and R component signals. As an alternate, low frequency driver 420d may be mounted on any surface of the speaker enclosure or mounted in a separate enclosure. It is well known in the art that low frequency drivers can be positioned virtually anywhere in the room due to the omnidirectional characteristic of low frequency audio signals. Left acoustic drivers 412a and 412b and right acoustic drivers 420a and 420b comprise mid-range drivers over a frequency response of approximately 200 Hz to approximately 5000 Hz. Mid-range drivers typically exhibit physical characteristics of having diameters of 1.5″ to about 5″, with a diameter of 2″ used in the preferred embodiment. It will also be apparent to one skilled in the art that an additional plurality of mid and high frequency drivers located on the top or side and such variations may further enhance speaker performance and is depicted schematically in FIG. 4. Acoustic drivers 412c and 420c may be high-frequency drivers or tweeters, with frequency performance from approximately 5000 Hz to 20,000 Hz.

In an alternate embodiment, a single enclosure may be utilized wherein speaker 402d has an increased frequency response over a wider range and mounted on the front while radiating the L+R channel. Drivers 420a and 412a are as above. Furthermore, in this alternate embodiment, only a single driver 420b is placed on the top of the speaker. Drivers 412b, 412c, and 420c are omitted. The R+L stereo channel is then coupled to drivers 420d and 420b, in equal power, while the L channel is coupled to driver 412a and the R, or right, channel is coupled to driver 420a. This alternate embodiment allows the invention to occupy the least amount of space while minimizing the amount of driver components required, and thus, is less costly to manufacture. Some practical tradeoffs with the choice of the alternate embodiment is the lower number of drivers may limit the maximum amount of sound power loudness that can be radiated due to driver physical characteristics. A further possible modification is to omit driver 420b entirely, and only couple the L+R channel to driver 420d.

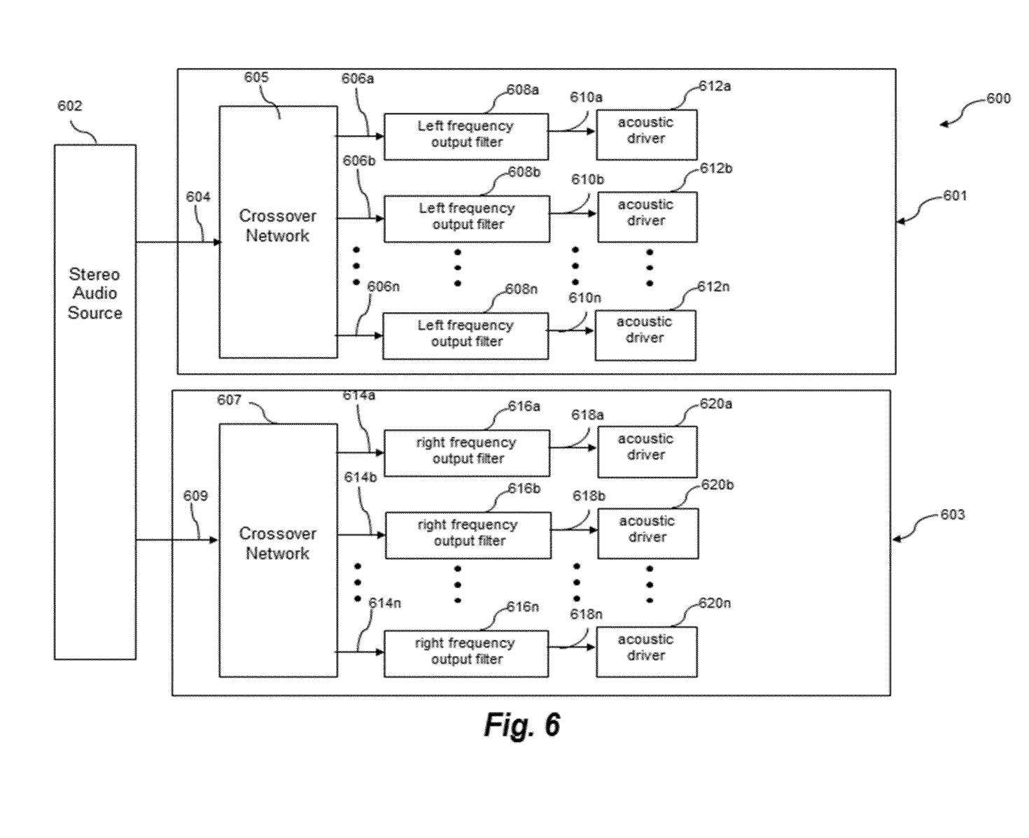

FIG. 6 shows a schematic block diagram of an acoustic speaker system in accordance with an alternate embodiment 600. The main functional difference between the preferred and alternate embodiments is that the alternate embodiment comprises two separate speaker enclosures, a left and right speaker, while the preferred embodiment comprises a single speaker enclosure. The signal couplings, features, and elements of the alternate embodiment are otherwise similar to the preferred embodiment. In an alternate embodiment, stereo audio source 602 is coupled to crossover networks 605 and 607 via connections 604 and 609 respectively, Crossover networks 605 and 607 both condition stereo audio source 602. Crossover network 605 outputs a set of signals comprising of at least one left output signal 606a, 606b, . . . , 606n. Similarly, Crossover network 607 outputs a set of signals comprising of at least one right output signal 614a, 614b, . . . , 614n. The main functionality of crossover networks 605 and 607 is to split up stereo audio source into two or more frequency bands, although typically low, mid, and high frequency, are known in the art. Amplification may also be used in crossover networks 604 and 609. Left output signal 606a, 606b, . . . , 606n and right output signal 614a, 614b, . . . , 614n are coupled to left frequency output filter 608a, 608b, . . . , 608n and right frequency output filter 616a, 616b, . . . , 616n, respectively. Left frequency output filter 608a, 608b, . . . , 608n and right frequency output filter 616a, 616b, . . . , 616n may comprise additional signal conditioning such as active or passive filtering, digital or analog filtering. The purpose of the left and right frequency output filters is to enhance the performance characteristics of individual acoustic drivers 612 and 620. As is known in the art, low frequency signals are typically coupled to low frequency acoustic drivers, mid frequency signals are coupled to mid frequency drivers and high frequency signals are coupled to high frequency drivers.

Left frequency output filter 608a, 608b, . . . , 608n and right frequency output filter 616a, 616b, . . . , 616n are coupled to left acoustic driver 612a, 612b, . . . , 612n and right acoustic driver 620a, 620b, . . . , 620n via left connection 610a, 610b, . . . , 610n and right connection 618a, 618b, . . . , 618n, respectively.

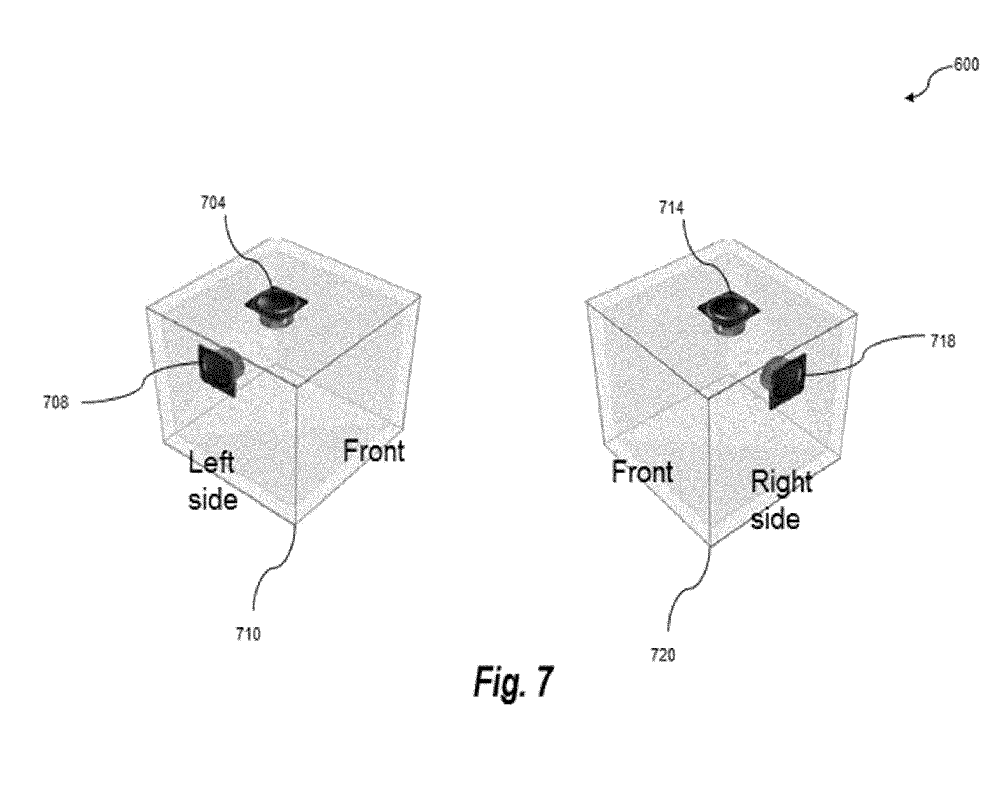

FIG. 7 shows an apparatus configuration and method of manufacture of acoustic speaker system 600 in accordance with an alternate embodiment. A method of manufacturing acoustic speaker system 600 comprises placing at least one speaker driver 708 on the left side of a speaker enclosure 710, and placing at least one speaker driver 704 mounted on the top side of left side speaker enclosure 710. The method of manufacture further comprises placing at least one speaker driver 718 on the right side of a right side speaker enclosure 720, and placing at least one speaker driver 714 mounted on the top side of right side speaker enclosure 720. Speaker enclosures 710 and 720 may have shape of a cube, rectangular prism, or any other physical shape wherein the respective driver placement allows for greater than 50% of the radiated acoustic power (“most”) from the respected driver to be radiated in a particular direction that is perpendicular to any other driver. For example, left side driver 708 would be mounted so that it radiates most of its acoustic power towards the left side. Similarly, top side driver 704 would be mounted so that radiates most of its acoustic power in an upward direction. In the case of a single driver on any one particular side, the driver might be chosen to have a broad range of frequency response over the entire audio frequency range of 20 Hz-20 kHz, or may be broadly responsive over any subset of frequencies.

The configuration depicted in FIG. 7 only has two drivers per left or right speaker enclosure. It will be apparent to one skilled in the art that additional drivers may be placed on the left and top sides of left side speaker enclosure 710 and additional drivers may be placed on the right and top sides of right side speaker enclosure 720. For example, multiple tweeters, mid-range and combination concentric drivers may be used on the top side of speaker enclosure 704.

In an alternate embodiment, a front firing driver such as 420d may be added to both the left and right speaker enclosure wherein front firing driver 420d may have extended frequency response over the entire audio range and wherein front firing driver 420d radiates L+R sound.

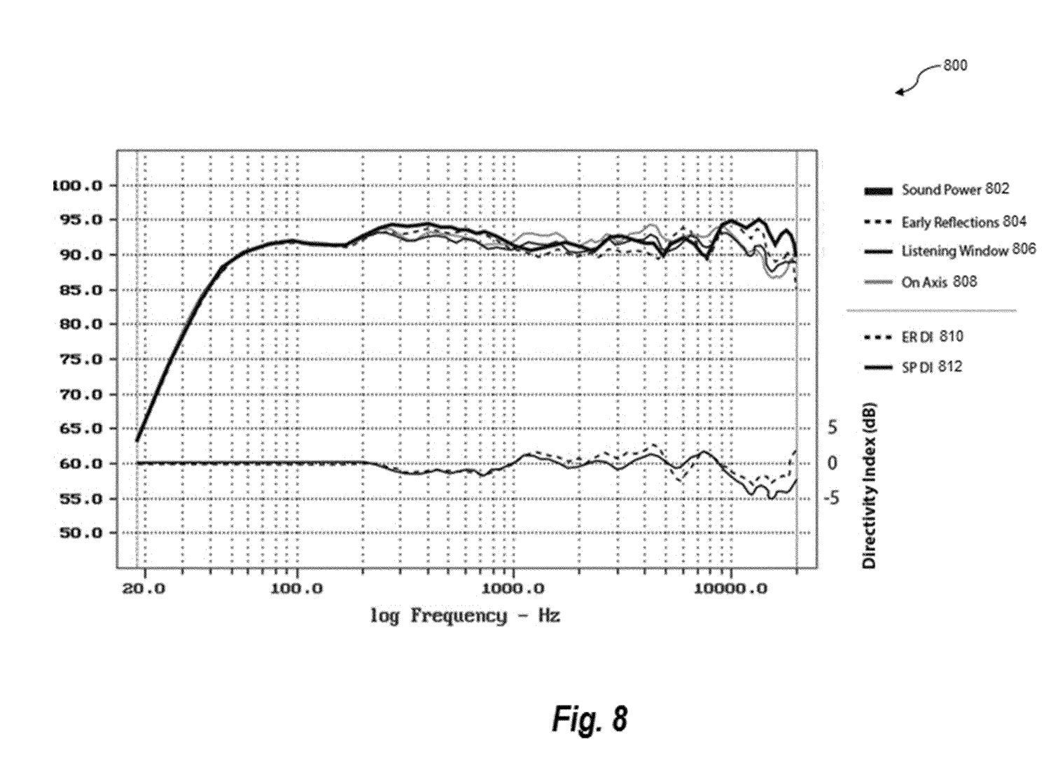

FIG. 8 shows invention performance 800 as measured by the standard, in accordance with the preferred embodiment 400 with the configuration depicted in FIG. 5. Invention sound power 802, invention early reflections 804, invention listening window 806, invention on Axis 808, invention early reflections directivity index (IERDI) 810, and invention sound power directivity index (ISPDI) 812 vary by less than approximately ±3 dB (“uniform”) throughout the entire frequency range of 20 Hz to 16 kHz. Furthermore, IERDI 810 and ISPDI 812 achieve a directivity value of less than 5 dB across the entire frequency range. Sound radiated through mid-range driver 412a is identical to sound radiated through mid-range driver 412b and sound radiated through mid-range driver 420a is identical to sound radiated through mid-range driver 420b. The main point of novelty which enables achieving uniform IERDI 810 and ISPDI 812 is the side and top mounted drivers.

In alternate embodiment, mid-range driver 412a may be configured to radiate an acoustic signal that is 180 degrees out of phase from mid-range driver 412b. Furthermore, mid-range driver 420b may be configured to radiate an acoustic signal that is 180 degrees out of phase from mid-range driver 420a. The net effect of out of phase radiated signals between the top and side mounted drivers is that a “nulling” effect is created on-axis, thus decreasing directivity and enhancing the “sense of space.” Because the out of phase nulling does not affect sound power, high frequency drivers 412c and 420c may be omitted. In the case when high frequency drivers 412c and 420c are omitted, selection of mid-range drivers should be made so that the drivers 412a, 412b, 420a, and 420b all may have frequency response throughout the mid and high frequency range (e.g. 300 Hz to 20 kHz). Furthermore, high frequency drivers 412c and 420c may be omitted in order to accommodate cost and packaging considerations.

With reference to speaker enclosure 506, the reference to top, right side, left side and front directions correspond respectively to the approximate radiation direction of the mounted drivers. Enclosure 506 may have varied dimensions of length, width and height, as it is apparent to one skilled in the art. For example, it is defined herein that “top” mounted refers to a mounting configuration wherein a “top” mounted driver has greater than 50% of its radiated power radiating in an upward direction. Similarly “left side” is a mounting configuration wherein a “left side” mounted driver has greater than 50% of its radiated power radiating in a direction approximately perpendicular to “top” and to the left of the on-axis reference 108. The same logic follows for “front” and “right side” configurations in light of FIG. 1.

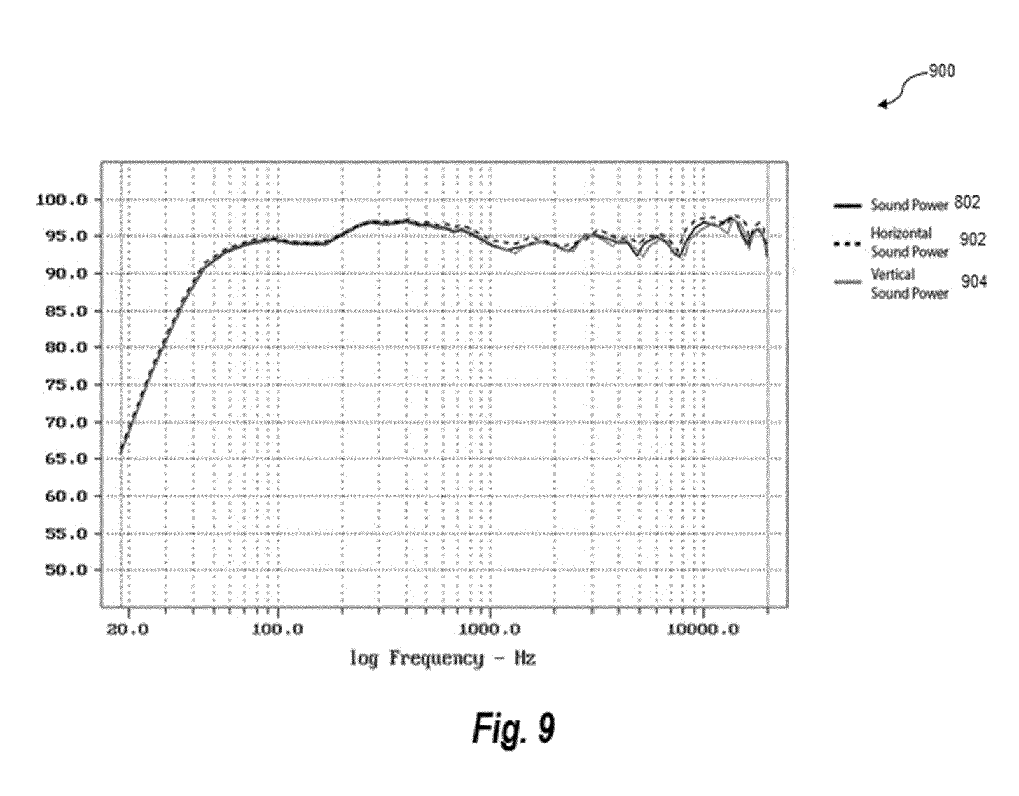

FIG. 9 shows invention sound power 802, invention horizontal sound power 902, and invention vertical sound power 904 in accordance with the preferred embodiment. It is apparent that both invention horizontal sound power 902 and invention vertical sound power 904 (as measured via methods outlined in the standard) are nearly identical to invention sound power 802. It follows that directivity in the horizontal and vertical direction will have less than ±3 dB of variability (“low variability” or “uniform”), resulting in a near identical listening experience on-axis, within the listening window, and outside the listening window (virtually throughout the room). These identical listening experiences throughout the room are highly desirable speaker features and a key achievement of the present invention.

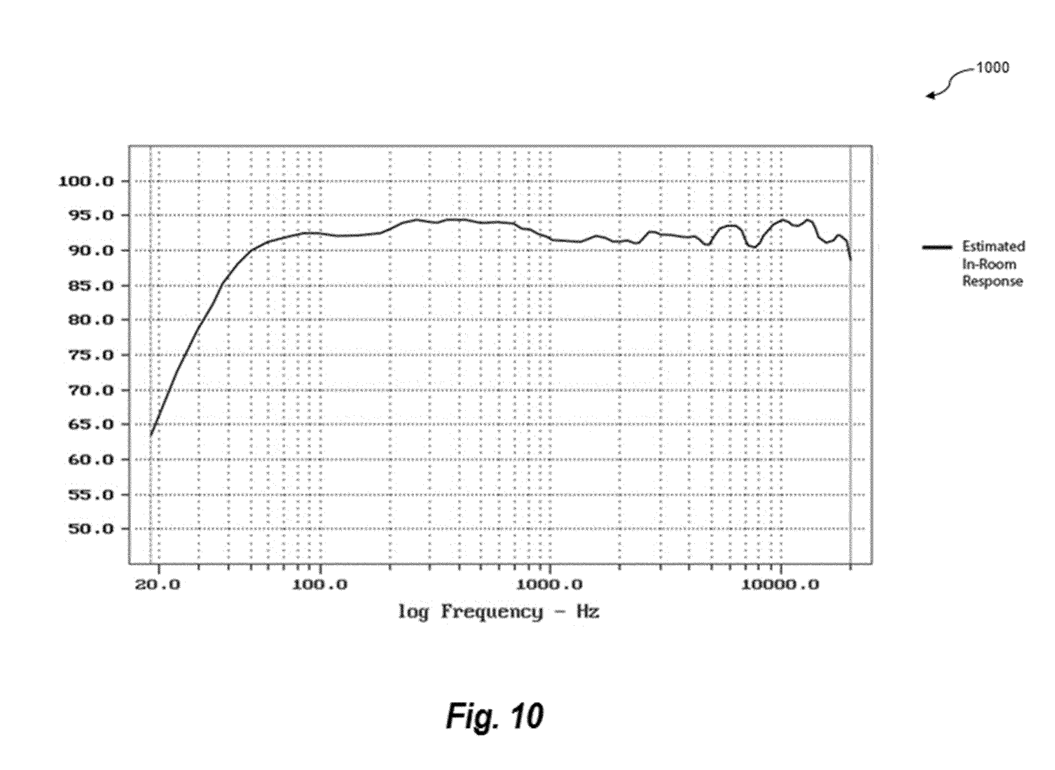

FIG. 10 shows the invention estimated in-room response 1000 as measured by the standard in accordance with a preferred embodiment. According to the standard, the estimated in-room response is a weighted average of horizontal and vertical position sound power measurements intended to model a “typical room.” The Estimated In-Room Response shall be comprised of a weighted average of 12% Listening Window, 44%, Early Reflections, and 44% Sound Power. The standard defines the estimated in-room response so that consumers can compare different speaker systems to make a better buying decision.

There have been several attempts by historical and existing speaker designs to achieve low directivity variability, while keeping sound power uniform. One existing speaker design that attempts to replicate low variability directivity are speakers with high frequency drivers facing upwards and a reflector above the drivers which diffuses the sound horizontally but not upwards (U.S. Pat. No. 6,257,365). Another existing design that attempts to replicate low variable directivity is with utilization of high frequency drivers tilted backwards and upwards (Patent DE 202010007297). Still another existing design is with speakers mounted on the sides and front (U.S. Pat. No. 8,542,854). None of these existing inventions has low variability directivity index while simultaneously exhibiting low variability horizontal and vertical sound power. Furthermore, no existing prior invention teaches simultaneous placing of side and top drivers. In addition, no existing prior invention teaches implementing side and top drivers with or without phase nulling, to enhance the sense of space.

As previously explained, an additional acoustic driver may be placed on the front side that is responsive to a frequency range of 20 Hz to 16 kHz. This additional acoustic driver is designed to radiate the left plus right channel of a stereo signal. In a related embodiment, instead of one acoustic driver, a pair (or more than one pair) of acoustic drivers is provided instead of one single acoustic driver. Each driver in the corresponding paid radiates the associated (left or right) channel of the stereo signal.

Those of skill in the art would appreciate that the preferred and alternate embodiments may be practiced on any item that may reproduce stereo sound, including, but not limited to, cellular phones, smartphones, televisions, stereo systems, portable computers, and desktop computers.

Those of skill in the art would understand that signals may be represented using any of a variety of different techniques. For example, data, instructions, signals that may be referenced throughout the above description may be represented by voltages, currents, electromagnetic waves, magnetic fields or particles, or any combination thereof.

Those of skill would further appreciate that the various illustrative blocks described in connection with the disclosure herein may be implemented in a variety of different circuit topologies, on one or more integrated circuits, separate from or in combination with logic circuits and systems while performing the same functions described in the present disclosure.

Those of skill would also further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a GPU core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor may read information from, and write information to, the storage medium. In the alternative, the storage medium may be integral to the processor. The processor and the storage medium may reside in an ASIC. The ASIC may reside in a user terminal or speaker. In the alternative, the processor and the storage medium may reside as discrete components in a user terminal or speaker.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but are to be accorded the widest scope consistent with the principles and novel features disclosed herein.

What is claimed is:

1. A method of manufacture of a speaker system designed to reproduce stereo sound, including a left and right channel, from a single speaker enclosure with a left side, top side, and right side, the method comprising:
placing at least one acoustic driver on the left side of the speaker enclosure, at least one acoustic driver on the right side of the speaker enclosure, and at least one acoustic driver on the top side of the speaker enclosure in a manner whereby the reproduced stereo sound is characterized by (i) sound power directivity of less than approximately 4 dB and (ii) sound power directivity variability of approximately ±3 dB over the frequency range of approximately 20 Hz to approximately 16 kHz,
the acoustic driver on the left side of the speaker representing the left channel of a stereo signal, the acoustic driver on the right side represent the right channel of the stereo signal, while the at least one acoustic driver on the top side radiates at least one of the left channel, the right channel, and a linear combination of the left and right channel of the stereo signal.

2. The method of claim 1, wherein there is at least three acoustic drivers on the top side of the speaker enclosure and wherein one of the at least three acoustic drivers on the top side of each left and right speaker enclosure is a high frequency driver, and wherein one of the at least three acoustic drivers on the top side of each left and right speaker enclosure is a mid-range frequency driver.

3. The method of claim 1, wherein the at least one acoustic driver on the left side radiates an identical acoustic signal to that of at least one acoustic driver on the top side and wherein the at least one acoustic driver on the right side radiates an identical signal to that of at least one acoustic driver on the top side.

4. The method of claim 1, wherein the at least one acoustic driver on the left side radiates an acoustic signal that is 180 degrees out of phase to the acoustic signal output by at least one acoustic driver on the top side and wherein the at least one acoustic driver on the right side radiates an acoustic signal that is 180 degrees out of phase to the acoustic signal output by at least one acoustic driver on the top side.

5. A method of manufacture of a speaker system designed to reproduce stereo sound, including a left and right channel, from left and right speaker enclosures each of which includes a left side, a right side, and front side, the method comprising:
placing at least one acoustic driver on the left side of the left speaker enclosure, at least one acoustic driver on the right side of the right speaker enclosure, and at least one acoustic driver on the top side of each of the left speaker enclosure and right speaker enclosure in a manner whereby the reproduced stereo sound is characterized by (i) sound power directivity of less than 4 dB and (ii) sound power directivity variability ±3 dB over the frequency range of 20 Hz to 16 kHz,
the acoustic driver on the left side of the left speaker enclosure radiating the left channel of a stereo signal, the acoustic driver on the right side of the right speaker enclosure representing the right channel of the stereo signal, while each of the acoustic drivers on the top side radiate at least one of: the left channel, the right channel, and a linear combination of the left channel and the right channel of the stereo signal.

6. The method of claim 5, wherein an additional acoustic driver, placed on each of a respective front side of each of the right and left enclosures and designed to be responsive over a frequency range of 20 Hz to 16 kHz, radiates both the left plus right channels of the stereo signal.

7. The method of claim 5, wherein each acoustic driver of a pair of acoustic drivers, placed on each of a respective front side of each of the right and left enclosures and designed to be responsive over a frequency range of 20 Hz to 16 kHz, radiate the respective one of the left and right channels of the stereo signal.

8. The method of claim 5, wherein the at least one acoustic driver on the left side of the left speaker enclosure outputs an identical acoustic signal to that of at least one acoustic driver on the top side of the left speaker enclosure and wherein the at least one acoustic driver on the right side of the right speaker enclosure outputs an identical signal to that of the at least one acoustic driver on the top side of the right speaker enclosure.

9. The method of claim 5, wherein the acoustic drivers on the left and top sides of the left speaker enclosure radiate acoustic signals that are approximately 180 degrees out of phase and wherein the acoustic drivers on the right and top sides of the right speaker enclosure radiate acoustic signals that are approximately 180 degrees out of phase

10. A speaker system designed to reproduce stereo sound, including a left and right channel, from a single speaker enclosure with a left side, top side, and right side, the speaker system including at least one acoustic driver on the right side of the speaker enclosure, and at least one acoustic driver on the top side of the speaker enclosure, and disposed such that the reproduced stereo sound is characterized by (i) a sound power directivity of less than approximately 4 dB and (ii) a sound power directivity variability of approximately ±3 dB over the frequency range of approximately 20 Hz to approximately 16 kHz,
the speaker system including (a) at least one acoustic driver on the left side of the speaker enclosure that represents the left channel of a stereo signal, and (b) an acoustic driver on the right side that represent the right channel of the stereo signal, whereby the at least one acoustic driver on the top side radiates at least one of the left channel, the right channel, and a linear combination of the left and right channel of the stereo signal.

11. The speaker system of claim 10, wherein there is at least three acoustic drivers on the top side of the speaker enclosure and wherein one of the at least three acoustic drivers on the top side of each left and right speaker enclosure is a high frequency driver, and wherein one of the at least three acoustic drivers on the top side of each left and right speaker enclosure is a mid-range frequency driver.

12. The speaker system of claim 10, wherein the at least one acoustic driver on the left side radiates an identical acoustic signal to that of at least one acoustic driver on the top side and wherein the at least one acoustic driver on the right side radiates an identical signal to that of at least one acoustic driver on the top side.

13. The speaker system of claim 10, wherein the at least one acoustic driver on the left side radiates an acoustic signal that is 180 degrees out of phase to the acoustic signal output by at least one acoustic driver on the top side and wherein the at least one acoustic driver on the right side radiates an acoustic signal that is 180 degrees out of phase to the acoustic signal output by at least one acoustic driver on the top side.

14. A computer readable media including a non-transient computer program product for designing a speaker system that reproduces stereo sound, the speaker system configuration being of the type including a left and right channel, from left and right speaker enclosures each of which includes a left side, a right side, and front side,
the computer readable media including instructions that facilitate
positioning at least one acoustic driver on the left side of the left speaker enclosure, at least one acoustic driver on the right side of the right speaker enclosure, and at least one acoustic driver on the top side of each of the left speaker enclosure and right speaker enclosure in a manner whereby the reproduced stereo sound is characterized by (i) sound power directivity of less than 4 dB and (ii) sound power directivity variability ±3 dB over the frequency range of 20 Hz to 16 kHz,
where
the acoustic driver on the left side of the left speaker enclosure radiates the left channel of a stereo signal,
the acoustic driver on the right side of the right speaker enclosure represents the right channel of the stereo signal, and
each of the acoustic drivers on the top side radiate at least one of: the left channel, the right channel, and a linear combination of the left channel and the right channel of the stereo signal.

15. The computer readable media of claim 14, wherein an additional acoustic driver, placed on each of a respective front side of each of the right and left enclosures and designed to be responsive over a frequency range of 20 Hz to 16 kHz, radiates both the left plus right channels of the stereo signal.

16. The computer readable media of claim 14, wherein each acoustic driver of a pair of acoustic drivers, placed on each of a respective front side of each of the right and left enclosures and designed to be responsive over a frequency range of 20 Hz to 16 kHz, radiate the respective one of the left and right channels of the stereo signal.
